(19) United States
(12) Patent Application Publication
(10) Pub. No.: US 2007/0273708 A1
(43) Pub. Date: Nov. 29, 2007

(54) READING GLASSES FOR THE COLOR BLIND

(76) Inventors: Markus ANDREASSON, Lund (SE); Marcel WONG, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/420,030

(22) Filed: May 24, 2006

(51) Int. Cl. G09G 5/02

(52) U.S. Cl. 345/593

(57) ABSTRACT

An electronic equipment includes an image storage device for capturing and/or storing data representative of an image, and an image processing circuit. The image processing circuit is operable to modify the stored image data when a color combination as defined in the image data corresponds to a color combination associated with color blindness. The modified image data then is provided to a display for viewing by a color blind individual.

### TECHNICAL FIELD OF THE INVENTION

The present invention relates generally to electronic equipment and, more particularly, to electronic equipment that enables a color blind individual to view objects, text, images, etc. that such individual may not be able to view with the naked eye, and a method of using electronic equipment to assist color blind individuals in viewing objects, text, images, etc.

### DESCRIPTION OF THE RELATED ART

Color blindness, or color vision deficiency, in humans is the inability to perceive differences between some or all colors that other people can distinguish. It is most often of genetic nature, but also may occur because of eye, nerve, or brain damage, or due to exposure to certain chemicals.

The normal human retina contains two kinds of light sensitive cells: the rod cells (active in low light) and the cone cells (active in normal daylight). Normally, there are three kinds of cones, each containing different pigment. The different kinds of color blindness result from one or more of the different cone systems either not functioning at all, or functioning in an unusual way.

When one cone system is compromised, dichromacy results. The most frequent forms of human color blindness result from problems with either the middle or long wavelength sensitive cone systems, and involve difficulties in discriminating reds, yellows, and greens from one another. They are collectively referred to as “red-green color blindness”, but this does not mean that such individuals cannot see reds or greens. They simply have a harder time differentiating between these colors. Not all reds and greens are indistinguishable. It would be easy for someone with a red-green deficiency to tell the difference between a light green and a dark red, for example. A lot depends on how dark the colors are. If the red is approximately as dark as the green, there is a greater likelihood that the colors will be confused.

Also, there is some evidence that people with red-green color-blindness see reds and greens as yellows, oranges and beiges. This means that yellows, oranges, and beiges can be confused with greens and reds. The colors least affected are the blues. There are several types of red-green color blindness, which are listed below.
1. Protanopia: Lacking the long-wavelength sensitive retinal cones, those with this condition are unable to distinguish between colors in the green-yellow-red section of the spectrum. They have a neutral point at a wavelength of 492 nm—that is, they cannot discriminate light of this wavelength from white. Their sensitivity to light in the orange and red part of the spectrum is also reduced.
2. Deuteranopia: Lacking the medium-wavelength cones, those affected are again unable to distinguish between colors in the green-yellow-red section of the spectrum. Their neutral point is at a slightly longer wavelength, 498 nm.
3. Protanomaly: Having a mutated form of the long-wavelength pigment, whose peak sensitivity is at a shorter wavelength than in the normal retina, protanomalous individuals are less sensitive to red light than normal. This means that they are less able to discriminate colors, and they do not see mixed lights as having the same colors as normal observers. They also suffer from a darkening of the red end of the spectrum. This causes reds to reduce in intensity to the point where they can be mistaken for black.
4. Deuteranomaly: Having a mutated form of the medium-wavelength pigment. The medium-wavelength pigment is shifted towards the red end of the spectrum resulting in a reduction in sensitivity to the green area of the spectrum. Unlike protanomaly the intensity of colors is unchanged. This is the most common form of color blindness.

Other forms of color blindness are much rarer than red-green color blindness. These other types include problems in discriminating blues from yellows, and the rarest forms of all, complete color blindness or monochromacy, where one cannot distinguish any color from grey, as in a black-and-white movie or photograph. Monochromacy occurs in three forms:
1. Cone monochromacy, where only a single cone system appears to be functioning, so that no colors can be distinguished, but vision is otherwise more or less normal.
2. Achromatopsia or rod monochromacy, where the retina contains no cone cells, so that in addition to the absence of color discrimination, vision in lights of normal intensity is difficult.
3. Color agnosia or “central achromatopsia”, where the person can not perceive colors, even though the eyes are capable of distinguishing them. Some sources do not consider this to be true color blindness, because the failure is of perception, not of vision. It is a form of visual agnosia.

There is no treatment or cure for color blindness. Those with mild color deficiencies learn to associate colors with certain objects and are usually able to identify color as everyone else. However, they are unable to appreciate color in the same way as those with normal color vision.

### SUMMARY

The present invention enables electronic equipment, such as a mobile phone or the like, to assist a color blind individual in viewing material that, due to the individual's color blindness, may be difficult or impossible for the individual to observe. The electronic equipment captures and/or stores images via an image storage device (e.g., a camera and/or memory system of the electronic equipment), and the captured image data is processed such that certain color combinations found within the image data are altered. The color combinations are altered in a manner that enables the color blind individual to easily distinguish between the colors (e.g., green pixels near red pixels may be changed to black pixels near white pixels, or dark green pixels near dark red pixels may be changed to light green pixels near dark red pixels). The altered image data then is provided to a display of the electronic equipment for viewing by the individual.

According to one aspect of the invention, there is provided an electronic equipment that includes an image storing device for capturing and/or storing data representative of an image, and an image processing circuit operable to modify the captured image data when a color combination as defined in the image data corresponds to a color combination associated with color blindness.

According to another aspect, the image processing circuit is operable to modify the image data so as to remove or minimize color combinations associated with color blindness.

According to another aspect, the image processing circuit is configurable so as to modify color combinations in the image data to compensate for one or more types of color blindness.

According to another aspect, the types of color blindness include at least one of protanopia, protanomaly, deuteranopia, deuteranomaly, tritanopia, rod monochromacy or achromacy.

According to another aspect, the image processing circuit is operable to convert at least the problematic color combinations to grayscale.

According to another aspect, the image storage device comprises an optical image capture device.

According to another aspect, the image storage device comprises a camera.

According to another aspect, the image storage device comprises a memory.

According to another aspect, the color combination associated with color blindness is user definable.

According to another aspect, the electronic equipment further includes a display for viewing the modified image data.

According to another aspect, the electronic equipment is a mobile phone.

According to another aspect, the electronic equipment is at least one of a personal audio device, a personal video device or a personal digital assistant.

Another aspect of the invention relates to a method for using an electronic equipment to enable a color blind individual to view content that would otherwise be difficult or impossible for the color blind individual to view, including: storing image data representative of the content; modifying the stored image data when a color combination as defined in the image data corresponds to a color combination associated with color blindness; and displaying the modified image data.

Another aspect of the invention relates to modifying the image data so as to remove or minimize color combinations associated with color blindness. Modifying the image data can include scanning a predefinable region around a data point of the image data for problematic color combinations.

Another aspect of the invention relates to configuring the electronic equipment so as to modify color combinations in the image data to compensate for one or more types of user definable color blindness. The types of color blindness can include at least one of Protanopia, Protanomaly, Deuteranopia, Deuteranomaly, Tritanopia, Rod Monochromacy or Achromacy.

Another aspect of the invention relates to configuring the electronic equipment so as to enable the color combinations associated with color blindness to be user definable.

Another aspect of the invention relates to a computer program operable in electronic equipment, said electronic equipment including an image storage device for storing image data and a display device for viewing the image data, including: code to operate the image storage device to store the image; code for causing the stored image data to be modified when a color combination as defined in the image data corresponds to a color combination associated with color blindness; and code to display the modified image data on the display device.

To the accomplishment of the foregoing and the related ends, the invention, then, comprises the features hereinafter fully described in the specification and particularly pointed out in the claims, the following description and the annexed drawings setting forth in detail certain illustrative embodiments of the invention, these being indicative, however, of but several of the various ways in which the principles of the invention may be suitably employed.

Other systems, methods, features, and advantages of the invention will be or become apparent to one with skill in the art upon examination of the following drawings and detailed description. It is intended that all such additional systems, methods, features, and advantages be included within this description, be within the scope of the present invention, and be protected by the accompanying claims.

Although the invention is shown and described with respect to one or more embodiments, it is to be understood that equivalents and modifications will occur to others skilled in the art upon the reading and understanding of the specification. The present invention includes all such equivalents and modifications, and is limited only by the scope of the claims.

Also, although the various features are described and are illustrated in respective drawings/embodiments, it will be appreciated that features of a given drawing or embodiment may be used in one or more other drawings or embodiments of the invention.

It should be emphasized that the term “comprise/comprising” when used in this specification is taken to specify the presence of stated features, integers, steps or components but does not preclude the presence or addition of one or more other features, integers, steps, components or groups thereof.”

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1A illustrates an exemplary image as may be viewed by non-color blind individuals.

FIG. 1B is the image of FIG. 1A as may be viewed by color blind individuals.

FIG. 1C illustrates an exemplary application of a mobile phone in accordance with the invention.

FIG. 2 is schematic illustration of an exemplary mobile phone.

FIG. 3 is a schematic block diagram of a number of exemplary relevant portions of the respective mobile phone of FIG. 2 in accordance with the present invention.

FIGS. 4A and 4B are flow charts representing exemplary operation of the electronic equipment in accordance with the present invention.

FIGS. 5A and 5B illustrate exemplary menu screens for configuring the electronic equipment in accordance with the invention.

### DETAILED DESCRIPTION OF EMBODIMENTS

The present invention will now be described with reference to the drawings, wherein like reference numerals are used to refer to like elements throughout.

The term “electronic equipment” includes portable radio communication equipment. The term “portable radio communication equipment,” which herein after is referred to as a “mobile radio terminal,” “mobile phone,” “mobile device,” or “mobile terminal” and the like, includes all equipment such as mobile telephones, pagers, communicators, i.e., electronic organizers, personal digital assistants (PDAs), smartphones, portable communication apparatus or the like. The term “electronic equipment” also may include portable digital music and/or video devices, e.g., iPod devices, mp3 players, portable game systems, etc.

In the present application, the invention is described primarily in the context of a mobile phone. However, it will be appreciated that the invention is not intended to be limited to a mobile phone and can be any type of electronic equipment.

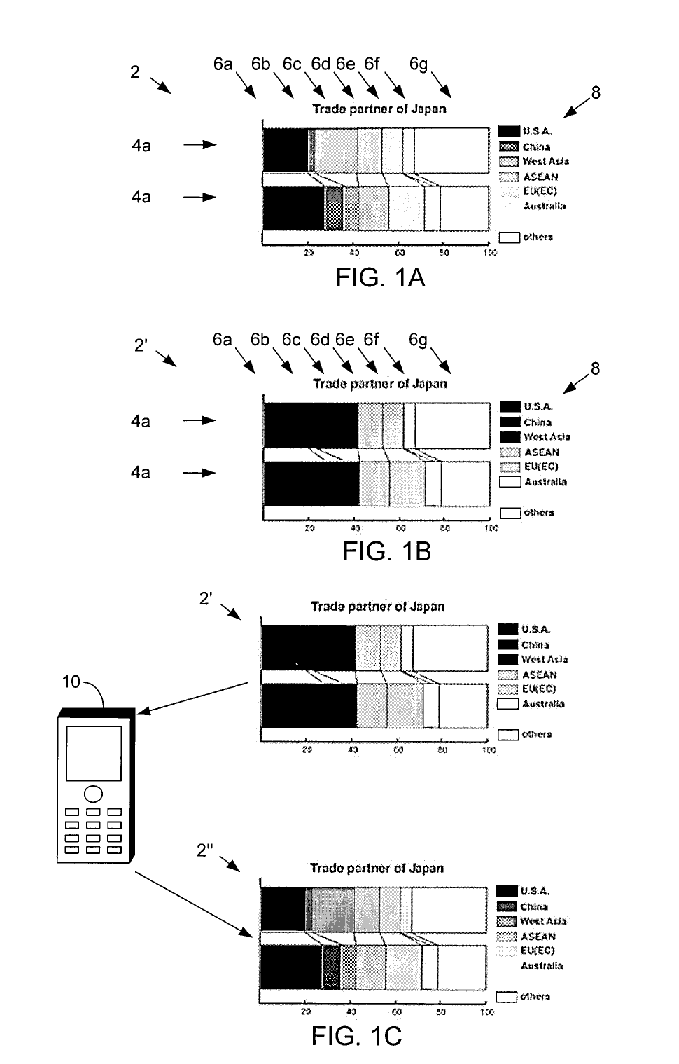

FIG. 1A illustrates an exemplary image 2 as may be viewed by a non-color blind individual. As can be seen in FIG. 1A, there are two bar graphs 4a and 4b having seven different segments 6a-6g, and a legend 8 that corresponds to the segments. The different segments 6a-6g and legend 8 of FIG. 1 can be distinguished from one another by their color (shown in grayscale in FIG. 1).

FIG. 1B illustrates the image of FIG. 1A as may be viewed by a color blind individual (also shown in grayscale). As is evident, the color blind individual may not be able to discern one segment 6a of the bar graph from another segment 6b, 6c, nor may he be able to correlate the legend 8 with the respective segments 6a-6g. Thus, the image 2′ of FIG. 1B, from the point of view of the color blind individual, is relatively useless, as he cannot extract enough information from the image to make it meaningful.

An electronic equipment, such as a mobile phone or the like, includes an image storage device for storing and/or capturing images (e.g., a camera, video recorder, memory, or any device that may capture and/or store image data, including image data in the form of electronic information such as web pages or photographs). The captured images may be stored in memory in the form of captured image data in any one of a number of conventional formats (e.g., jpg, bmp, gif, etc.). The electronic equipment further includes an image processing circuit operable to analyze the captured image data and, if deemed necessary, modify the image data so as to remove or minimize potential color combinations that may be problematic for color blind individuals (e.g., combinations that are difficult or impossible for a color blind individual to distinguish from one another).

For example, red-green color blind individuals have difficulty in discerning green colors from red colors, particularly when the colors are next to or near each other and/or when such colors are dark in shade. Such color combinations can be modified by the image processing circuit so as to remove or minimize these problematic color combinations.

More specifically, and with reference to FIG. 1C, the image storage device can be used to store and/or input into the mobile phone 10 image data corresponding to the image (e.g., the bar graph 2′ as seen by a color blind individual—shown in grayscale). Once provided to the mobile phone, the image processing circuit can modify the image data so as to remove problematic color combinations from the image data. The modified image data then is provided to a display, such as a display of the mobile phone, in a form that is readable by the color blind individual (e.g., the modified bar graph 2″ as seen by a color blind individual—shown in grayscale).

The image modifications may include, for example, lightening a shade of one color of the problematic colors relative to the other color of the problematic colors (e.g., changing the dark green portion to light green while maintaining the dark red portion), or altering both color portions (e.g., changing the dark green portions to black and changing the dark red portions to white, or some other color within grayscale). As will be appreciated, any number of changes may be made to the respective color portions, so long as the changes minimize the occurrence of problematic color combinations being next to or near each other.

As used herein, a color combination is defined as two or more different colors (or different shades of a color), that are next to or near each other. A problematic color combination is defined as two or more different colors (or different shades of a color) that, when next to or near each other, are difficult for an individual to distinguish from one another using the unassisted or naked eye.

It is noted that modification of the image data may be based on any type of color blindness, and reference to red-green color blindness is merely exemplary. For example, the modification may be based on other forms of dichromacy, anomalous trichromacy, and/or monochromacy.

Further, while the drawings are shown in grayscale, the actual display on the electronic equipment may be in color or grayscale.

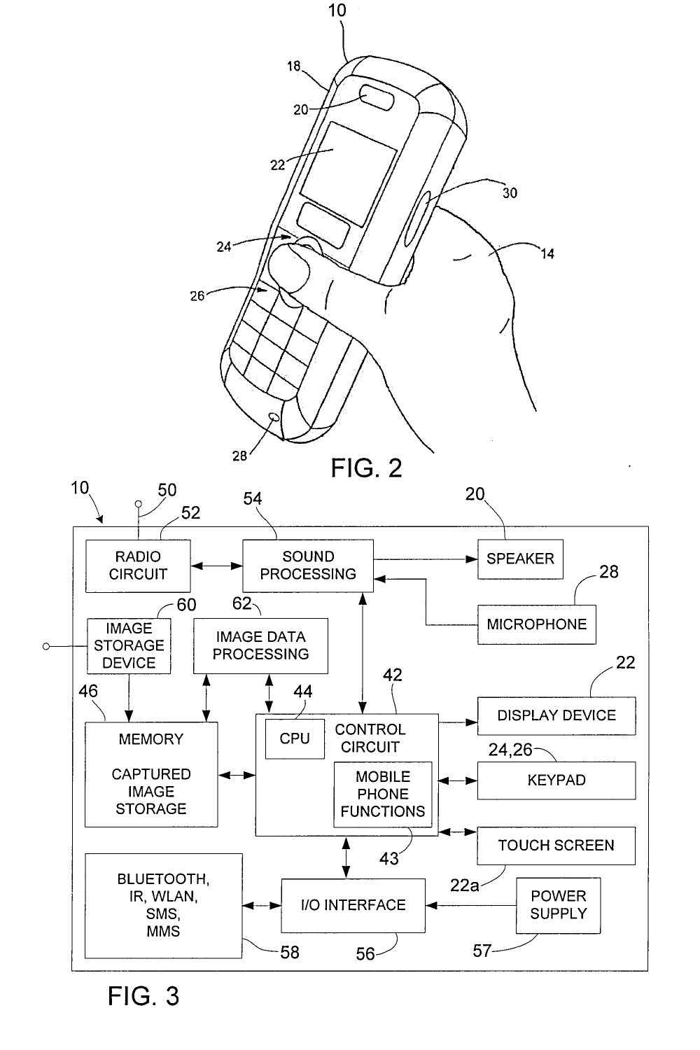

Referring now to FIG. 2, a mobile phone 10 is shown as having a “brick” or “block” design type housing 18, but it will be appreciated that other type housings, such as, for example, claim shell or slide-type housings, may be utilized without departing from the scope of the invention. The mobile phone 10 includes housing 18 (sometimes referred to as a case), speaker 20, display 22, navigation switch and selection/function keys or switches 24, key pad 26, microphone 28, and volume control slide switch 30; these are illustrative and exemplary of parts of a typical mobile phone, but it will be appreciated that other parts that are similar or different in form and/or function may be included in the mobile phone 10. The mobile phones to which the invention pertains also may be of the types that have more or fewer functions, keys, etc., compared to those illustrated and described herein.

As will be appreciated, the mobile phone 10 may function as a conventional mobile phone. The mobile phone 10 may have additional functions and capabilities that may be developed in the future. From a conventional point of view, the display 22 displays information to a user, such as operating state, time, phone numbers, contact information, various navigational menus, etc., which facilitate and/or enable the user to utilize the various features of the mobile phone. Additionally, the display may be used to view modified images as described in more detail below. Part or all of the display 22 may be a touch screen type device 22a (FIG. 3). The navigation and function keys 24 and the keypad 26 may be conventional in that they provide for a variety of user operations. For example, one or more of the function keys and navigation device 24 may be used to navigate through a menu displayed on the display 22 to select different phone functions, profiles, settings, etc., as is conventional. The keypad 26 typically includes one or more special function keys, such as, a “call send” key for initiating or answering a call, a “call end” key for ending or hanging up a call, and dialing keys for dialing a telephone number. Other keys included in the navigation and function keys 24 and/or keypad 26 may include an on/off power key, a web browser launch key, a camera key, a voice mail key, a calendar key, etc. The volume control switch 30 may be operated to increase or to decrease the volume of the sound output from the speaker 20. If desired, a sensitivity control also may be provided to change the sensitivity of the microphone 28 as it picks up sounds for transmission by the mobile phone 10. The mobile phone 10 may have more of fewer keys, navigation devices, etc., compared to those illustrated.

FIG. 3 represents a functional block diagram of an exemplary mobile phone, for example, the mobile phone 10. The representation also is similar to those of PDAs and/or other electronic equipment, as will be appreciated by those having ordinary skill in the art. The construction of the mobile phone 10, which is presented by way of example here, is generally conventional with the exception of the capability provided by the image storage device 60 and image processing circuit 62, and use of data provided by the image storage device 60 and image processing circuit 62, as described in greater detail below. The various functions carried out by the parts represented in the functional block diagram of FIG. 3 may be carried out by application software within the mobile phone 10. However, it will be apparent to those having ordinary skill in the art that such operation can be carried out via primarily software, hardware, firmware, or a combination thereof, without departing from the scope of the invention.

The mobile phone 10 includes a primary control circuit 42 that is configured to carry out overall control of the functions and operations of the mobile phone 10, e.g., as is represented at block 43. The control circuit 42 may include a CPU 44 (central processor unit), microcontroller, microprocessor, etc., collectively referred to herein simply as CPU 44. The CPU 44 executes code stored in memory within the control circuit 42 (not shown) and/or in a separate memory 46 in order to carry out conventional operation of the mobile phone functions within the mobile phone 10.

Continuing to refer to FIG. 3, the mobile phone 10 includes a conventional antenna 50, radio circuit 52, and sound processing signal circuit 54, all of which are cooperative to send and to receive radio frequency (or other) signals in conventional manner. For an incoming signal, for example, the sound processing signal circuit 54 may include an amplifier to amplify the signal and to provide it to the speaker 20 so a user may hear the sound, and the sound processing signal circuit 54 also may use the same amplifier or another amplifier to amplify signals from the microphone 28 for transmitting thereof via the radio circuit 52 and antenna 50 to another mobile telephone, to a cellular phone tower, to a satellite, etc. Operation of the radio circuit 52, sound processing signal circuit 54, speaker and microphone, are under control of the control circuit 42, as is conventional.

The mobile phone 10 includes the display device 22, keypad 24, 26 (including the navigation device mentioned above), and the capability of a touch screen 22a, which may be part or all of the display device 22, and these are coupled to the control circuit 42 for operation as is conventional.

As is illustrated in FIG. 3, the mobile phone 10 includes an input/output interface 56, a power supply 57, and a short distance communications mechanism 58, for example a Bluetooth communications device, infrared (IR) communications device, or some other device. Another example of a short distance communications mechanism is wireless local area network (WLAN), and the invention also may use still other short distance communications mechanisms or devices that currently exist or may be developed in the future. The short distance communications mechanism 58 may transmit and receive signals using SMS (short message service), MMS (multimedia messaging service) or some other communications mechanism and protocol. Bluetooth, IR, WLAN communications for communicating over short distances between mobile phones are well known; other mechanisms may exist and/or may be developed in the future, and these may be utilized by and are included for use in the invention.

The mobile phone 10 also includes the aforementioned image storage device 60, such as a camera, memory, or the like. The image storage device 60 is used to capture and/or store image data in the mobile phone 10, wherein the image data may be stored in any one of a number of conventional formats (e.g., bitmap or bmp, jpeg, gif, tiff, or any other format for storing image data). As will be appreciated, activation of image storage may be enabled via a function key, soft menu, or any other form for enabling and disabling features of electronic equipment. Preferably, the image storage device 60 is a movie camera or the like that can obtain image data at a rate of thirty frames per second or greater. In this manner, the image data can be processed and provided to the display device 22 at a smooth frame rate in substantially real time. Alternatively, the image storage device 60 may be a single shot camera or the like that can obtain and store one or more snapshots of an image, or a memory that receives electronic information relating to an image (e.g., from a web page or email).

Further, the image storage device may be remote from the electronic equipment. For example, a camera may be mounted to the user's head (e.g., via a band or other means for securing equipment to an individual), and the camera may wirelessly transmit image data to the mobile phone via the short distance communications mechanism 58.

Image data captured and/or stored by the image storage device 60 is analyzed by the image data processing circuit 62 and, based on predetermined criteria, the image data is altered by the image data processing circuit prior to displaying the image data on the display device 22. More specifically, each data point (e.g., each pixel) and regions near or around each data point (e.g., pixels within about a one, five or ten-pixel radius of the data point) are scanned for color content. If the color content of the data point and the respective regions match known problematic color combinations, then the color of the data point and/or the regions is/are altered such that they do not fall within the problematic color combinations.

For example, if a data point or group of data pints is/are identified as having a dark green color, and regions next to or near the data point/group are identified as having dark red color (dark green and dark red are known problematic color combinations), then, for example, the shade of the data point/group is lightened (e.g., dark green is changed to light green). In this manner, the data point/group and the regions around the data point/group no longer fall within the known problematic color combinations for color blind individuals and/or may be considered problematic but at least distinguishable by the color blind individual. As will be appreciated, problematic color combinations can be any color combination that is difficult or impossible for color blind individuals distinguish between colors of the color combination, and reference to red-green color combinations is merely exemplary.

It is noted that during the analysis of the image data by the image data processing circuit 62, the relative distance that the image data processing circuit 62 scans around each data point (e.g., the distance between a data point and a surrounding regions of data points) may vary depending on a number of factors. For example, the level or degree of color blindness of the individual may dictate that a tighter or looser window should be applied around each data point. Further, the mobile phone 10 may be configured so as to enable the individual to dictate the precision in which the image data processing circuit 62 scans the regions around each data point.

Some guidelines for changing colors are provided in a-f below. It is noted that these guidelines are merely exemplary and numerous other guidelines may be applied by the image data processing circuit 62.
a) Substitute vermilion for red.
b) Avoid use of colors between yellow and green, since they are indistinguishable with yellow and orange.
c) Substitute bluish green for green so that it will not be confused with red or brown.
d) Substitute reddish purple for violet (which appears blue to color blind individuals).
e) Put distinct differences in brightness between two warm colors or two cool colors.
f) Alternate between warm and cool colors.

Further, while the exemplary embodiment illustrates a separate image data processing circuit for analyzing and modifying the image data, it will be appreciated by those having ordinary skill in the art that the functionality of the image data processing circuit 62 may be carried out by the CPU 44 (e.g., via code executed by the CPU 44).

A person having ordinary skill in the art of computer programming and applications of programming for mobile phones would be able in view of the description provided herein to program a mobile phone 10 to operate and to carry out the functions described herein. Accordingly, details as to the specific programming code have been omitted for the sake of brevity. Also, while software in the memory 46 or in some other memory of the mobile phone 10 may be used to allow the mobile phone to carry out the functions and features described herein in accordance with the preferred embodiment of the invention, such functions and features also could be carried out via dedicated hardware, firmware, software, or combinations thereof, without departing from the scope of the invention.

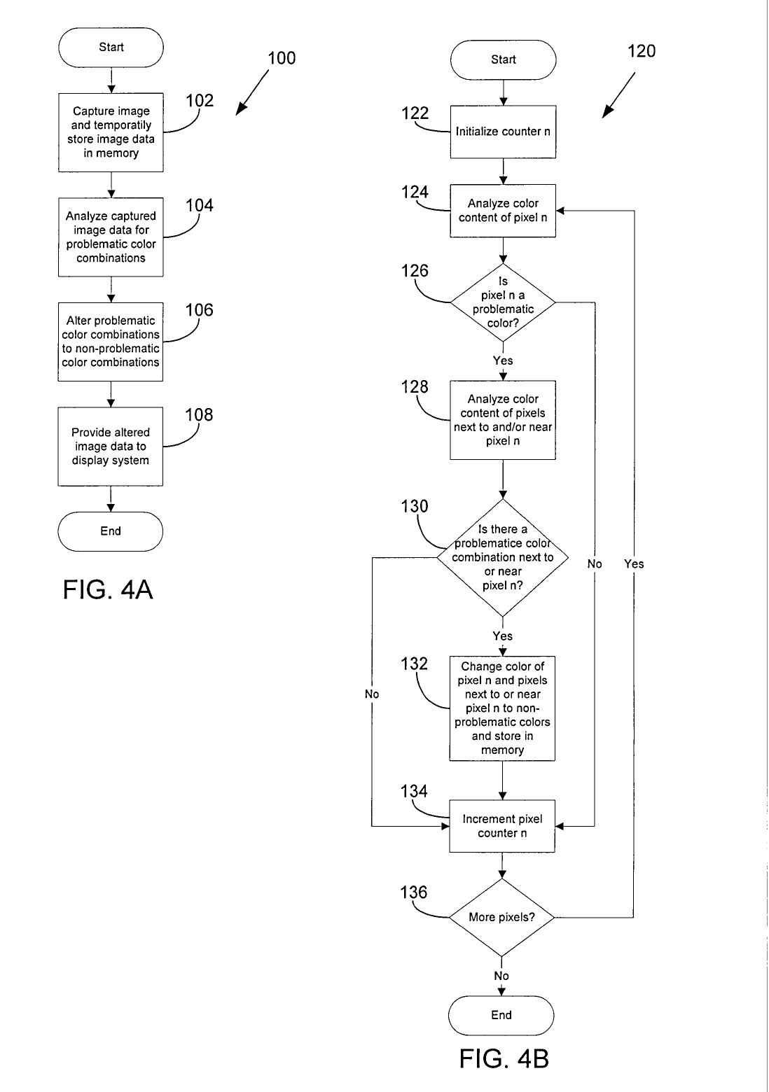

FIGS. 4A and 4B illustrate representative flow charts 100 and 120 showing exemplary steps, functions and methods that may be carried out using the invention. The flow charts include a number of process blocks arranged in a particular order. As should be appreciated, many alternatives and equivalents to the illustrated steps may exist and such alternatives and equivalents are intended to fall within the scope of the claims appended hereto. Alternatives may involve carrying out additional steps or actions not specifically recited and/or shown, carrying out steps or actions in a different order from that recited and/or shown, and/or omitting recited and/or shown steps. Alternatives also include carrying out steps or actions concurrently or with partial concurrence.

The steps shown in the flow chart may be carried out using a mobile phone, for example, of the type described herein or other type. Appropriate programming code may be written in an appropriate computer language or the like to carry out the steps, functions and methods as now are described with respect to FIGS. 4A and 4B. The steps shown in the flow chart are referred to below as blocks.

Beginning at block 102 of FIG. 4A, an image is captured and/or stored by the image storage device 60. For example, a color blind individual may be viewing a magazine article, an instruction manual, or any other image that potentially has problematic color combinations. The individual may point the image storage device 60 of the mobile phone 10 at the image, and the image storage device 60 inputs and stores the image into the mobile phone in the form of image data. The image data may be stored in memory 46 for further processing by the image data processing circuit 62 and/or the control circuit 42. Alternatively, the image may be in electronic form (e.g., a web page, a photograph received as an email attachment, etc.). In this example, the image storage device 60 may be a memory of the mobile phone 10, and the image data (e.g., the web page code, the photo file) may be downloaded and stored in the memory. As will be appreciated, the mobile phone 10 may include an image storage device 60 that comprises both a camera and a memory.

At block 104 the captured image data is analyzed by the image data processing circuit 62. Specifically, the image data processing circuit 62 checks for the occurrence of problematic color combinations. If problematic color combinations are not found, then the image data is not modified. However, if problematic color combinations are found, then at block 106, image data corresponding to the problematic color combinations is altered so as to remove the problematic combinations. At block 108, the image data (modified or unmodified) is provided to the control circuit 42, which prepares the image data for viewing on the display 22.

Referring now to FIG. 4B, further detail with regard to blocks 104 and 106 of FIG. 4A are provided. As will be appreciated, FIG. 4B is merely exemplary of one implementation of blocks 104 and 106, and those skilled in the art will recognize other methods of implementing these features.

Beginning at block 122, a counter that corresponds to a data point within the captured image data is initialized. For example, the number of data points (e.g., pixels) that make up the image may be determined from the captured image data, and each data point of the captured image data may be given an identifier. The current value of the counter can represent one data point of the total number of data points. At block 124, the color content of the data point corresponding to the current value of the counter is analyzed, and at block 126, it is determined whether the color is a problematic color. As is well known, some colors are classified as non-problematic colors (color blind individuals can distinguish such colors from other colors). Thus, if the color is a non-problematic color, there is no need to check the surrounding colors, and the method moves to step 134 to increment the counter.

If the color of the data point belongs to the group of colors that could pose a problem for color blind individuals, then data points near the current data point are checked to determine whether or not there is a problematic color combination, as indicated at block 128. This can be done, for example, by scanning the color content for all data points within a predefined distance of the current data point, and comparing the resulting color combinations with known problematic combinations. Further, the predefined distance between the current data point and neighboring data points may vary based on the type and/or degree of color blindness experienced by the individual. Preferably, the sensitivity of the search (e.g., the relative distance from the current data point to neighboring data points) is user adjustable.

At block 130, if a problematic color combination is not found, then the method moves to block 134 and increments the counter. However, if a problematic color combination is found, then at block 132 the color data for the current data point (and/or for the neighboring data points that form the problematic color combination) is/are changed so as to remove the problematic color combination. Further, once a problematic color combination is identified, the scope of the color change may expand beyond the predefined scan region.

For example, if a dark green bar graph segment (e.g., segment 6a of FIG. 1A) is found next to a dark red bar graph segment (e.g., segment 6b of FIG. 1A), only those data points near the color transition region may fall within the predefined scan range (e.g., 10 pixels), which would exclude a large portion of the segment 6a. However, once a problematic color combination is identified, the method may scan the image data to determine if there is a continuous range of data points that exhibit the same color data. Then the color data for these continuous regions also are changed in the same manner as the data point and/or the neighboring regions.

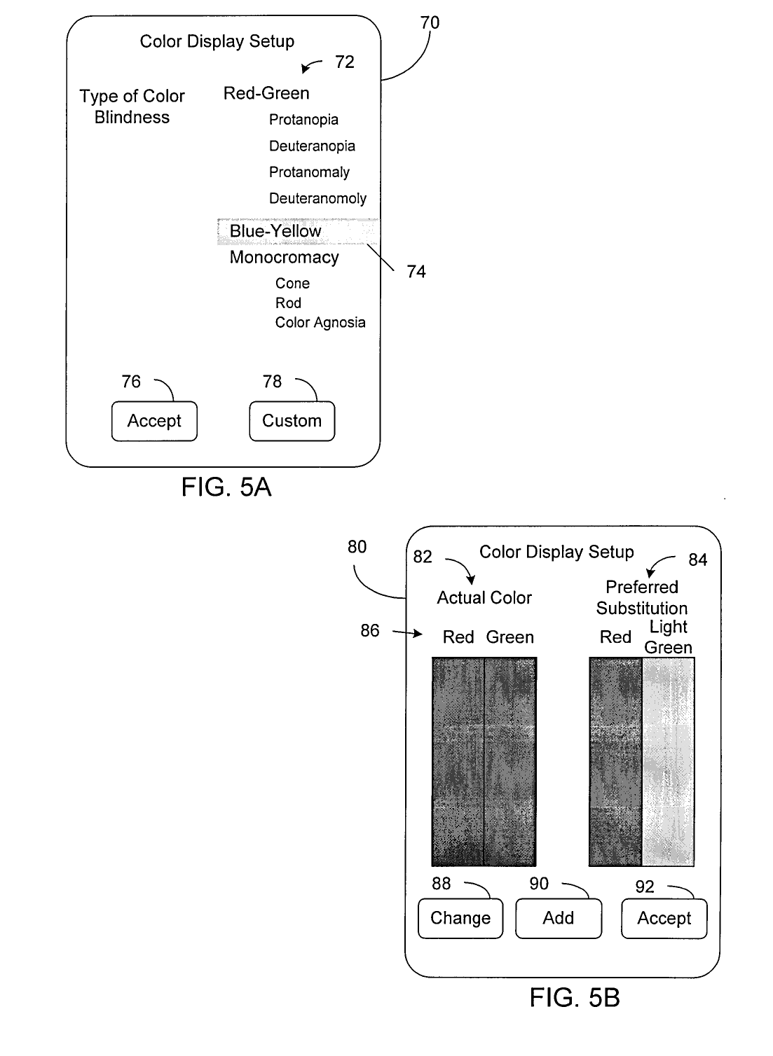

The color change, for example, may be based on predetermined guidelines as described herein, or on other guidelines. For example, and briefly referring to FIG. 5A, there is shown a setup screen 70 for adjusting color substitution guidelines. The setup screen 70 may include a number of predefined types of color blindness 72, and the user may select any of the different types of color blindness using the keypad 24, 26, for example, by scrolling up or down the list (e.g., the grayed area 74 can indicate the current selection). Once the user has selected the type of color blindness, he may use the Accept entry 74 via the keypad 24, 26 to enable the selected color substitutions within the mobile phone 10.

Alternatively, the user may adjust or define the guidelines based on his or her preferences by selecting the Custom entry 78. This selection displays a color calibration screen 80 on the display 22, as shown in FIG. 5B. The calibration screen 80 may display a number of problematic color combinations and the user, via the keypad 24, 26, may select the desired substitution for each color combination. In the example of FIG. 5B, the user is shown an actual problematic color combination 82 (e.g., red and green—shown in grayscale in FIG. 5B), and a preferred substitution 84 (e.g., red and light green—shown in grayscale in FIG. 5B). Additionally, a description 86 of each color can be provided to assist the user in identifying the colors. Preferably, each problematic color combination is sequentially displayed on the display 22, and the user may select a desired substitution using the keypad 24, 26. Once a substitution is entered (e.g., by selecting the Accept entry 88), the user may be presented with the next color combination in the sequence, and the user again selects the desired substitution. This process can be repeated until the color substitutions for the problematic color combinations have been defined. Further, the user may add problematic color combinations that may not be predefined in the system. For example, if the user has trouble with a specific color combination that is not generally recognized as a problematic color combination, the user may select the Add entry 90 to add this color combination to the system and the preferred substitution for the color combination. Once the user is satisfied with the changes, he may save them using the Accept entry 92.

Regardless of which guidelines are used for changing the colors of the respective data points, the colors are changed such that problematic color combinations are avoided or minimized. In this manner, color blind individuals will be able to distinguish between colors when the image is provided to the display 22.

Referring back to block 134 of FIG. 4B, the counter is incremented, and at block 136 it is determined if there are additional data points that need to be checked for problematic color combinations. If there are additional data points, then the method moves back to block 124 and the process repeats. If all relevant data points have been checked, then the process is complete and the modified image data is provided to the control circuit 42, which converts the data into a format useable by the display 22. As a result, an image that was previously un-interpretable by a color blind individual may now be interpreted via the display 22 of the mobile phone 10.

Specific embodiments of the invention have been disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. An electronic equipment, comprising:
an image storage device for capturing and/or storing data representative of an image; and
an image processing circuit operable to modify the captured image data when a color combination as defined in the image data corresponds to a color combination associated with color blindness.

2. The electronic device of claim 1, wherein the image processing circuit is operable to modify the image data so as to remove or minimize color combinations associated with color blindness.

3. The electronic equipment of claim 1, wherein the image processing circuit is configurable so as to modify color combinations in the image data to compensate for one or more types of color blindness.

4. The electronic equipment of claim 3, wherein the types of color blindness include at least one of protanopia, protanomaly, deuteranopia, deuteranomaly, tritanopia, rod monochromacy or achromacy.

5. The electronic equipment of claim 1, wherein the image processing circuit is operable to convert at least the problematic color combinations to grayscale.

6. The electronic equipment of claim 1, wherein the image storage device comprises an optical image capture device.

7. The electronic equipment of claim 1, wherein the image storage device comprises a camera.

8. The electronic equipment of claim 1, wherein the image storage device comprises a memory.

9. The electronic equipment of claim 1, wherein the color combination associated with color blindness is user definable.

10. The electronic equipment of claim 1, further comprising a display for viewing the modified image data.

11. The electronic equipment of claim 1, wherein said electronic equipment is a mobile phone.

12. The electronic equipment of claim 1, wherein said electronic equipment is at least one of a personal audio device, a personal video device or a personal digital assistant.

13. A method for using an electronic equipment to enable a color blind individual to view content that would otherwise be difficult or impossible for the color blind individual to view, comprising:
capturing and/or storing image data representative of the content;
modifying the stored image data when a color combination as defined in the image data corresponds to a color combination associated with color blindness; and
displaying the modified image data.

14. The method of claim 13, further comprising modifying the image data so as to remove or minimize color combinations associated with color blindness.

15. The method of claim 13, wherein modifying includes scanning a predefinable region around a data point of the image data for problematic color combinations.

16. The method of claim 13, further comprising configuring the electronic equipment so as to modify color combinations in the image data to compensate for one or more types of user definable color blindness.

17. The method of claim 16, wherein the types of color blindness include at least one of Protanopia, Protanomaly, Deuteranopia, Deuteranomaly, Tritanopia, Rod Monochromacy or Achromacy.

18. The method of claim 13, further comprising configuring the electronic equipment so as to enable the color combinations associated with color blindness to be user definable.

19. A computer program operable in electronic equipment, said electronic equipment including an image storage device for storing image data and a display device for viewing the image data, comprising:
code to operate the image storage device to capture and/or store the image;
code for causing the stored image data to be modified when a color combination as defined in the image data corresponds to a color combination associated with color blindness; and
code to display the modified image data on the display device.
